(19) United States
(12) Patent Application Publication
(10) Pub. No.: US 2003/0002091 A1
(43) Pub. Date: Jan. 2, 2003

(54) Method and apparatus for moving scanning documents

(76) Inventor: Alpha Hou, San Jose, CA (US)

Correspondence Address: Joe Zheng, SVPA, 7394 Wildflower Way, Cupertino, CA, 95014, US

(21) Appl. No.: 09/894,291

(22) Filed: Jun. 27, 2001

(51) Int. Cl. H04N 1/04

(52) U.S. Cl. 358/496; 358/497

(57) ABSTRACT

A sheet-fed scanner employing a second motion roller is disclosed. According to one embodiment, a transparent circular tube as the second roller is used. The image sensing module is enclosed in the transparent circular tube. With a parallel mounting of the transparent circular tube and a motion roller, the transparent circular tube is caused to rotate in synchrony with the motion roller by friction created between a scanning sheet and the transparent circular tube so as to reduce the friction to maintain a net driving force from the motion roller to advance a scanning sheet therebetween.

### CROSS-REFERENCE TO RELATED APPLICATION

This application is related to co-pending U.S. application Ser. No. 09/154,395, entitled “lightweight mobile scanners”, filed Sep. 16, 1998, now allowed, by Darwin Hu, et al, one of which is the inventor thereof, which is hereby incorporated by reference. This application is also related to co-pending U.S. application Ser. No. 09/829,259, entitled “Image Sensing Modules for Portable Optical Scanners”, filed Apr. 9, 2001 by the inventor hereof.

### FIELD OF THE INVENTION

The present invention generally relates to a scanning system and more particularly relates to solutions for reliably driving a scanning material through a sheet-fed scanner, wherein the scanning material or document has at least one side being glossy or rough.

### BACKGROUND OF THE INVENTION

There are many applications that need optical scanners to convert paper and plastics-based objects, such as texts and graphics, to an electronic format that can be subsequently analyzed, distributed and archived. One of the most popular types of optical scanners is a flatbed scanner that converts scanning objects, including pictures, papers and transparencies, to images that can be used, for example, for building World Wide Web pages and optical character recognition. Another type of popular optical scanner is what is called sheet-fed scanners that are small and unobtrusive enough to sit between a keyboard and a computer monitor or integrated into a keyboard/portable device to provide a handy scanning means. Most optical scanners are referred to as image scanners as the output thereof is generally in digital image format.

Most of the image scanners provided with a portable device are sheet-fed scanners. As a sheet-fed scanner operates automatically, namely a scanning document is well controlled by the scanner while passing through an image sensor in the sheet-fed scanner, the resultant image quality is generally satisfactory.

In many cases, there is a need to convert scanning objects with at least one side being glossy or shiny into images so that the information in the scanning objects can be, for example, electronically analyzed, edited, distributed or archived. The conversion is currently done through a specially designed film scanner, often bulky and run by a separate service. Examples of such glossy or shiny material may include printed pictures, negative or positive films, transparencies for an overhead projector or X-ray films. It may be experienced that a hesitant or slippery motion of such scanning materials in the sheet-fed scanner leads to smeared image. For example, when a sheet of glossy picture paper is fed into a sheet-fed scanner, the feeding or motion of the paper could be sometimes skewed or mis-feeding through the scanner and thus causes a smeared or skewed image. One of the primary reasons of causing such smeared or skewed image is the moving mechanism in the scanner that could not scroll such “slippery” material well enough. There is, therefore, a need for solutions for a sheet-fed scanner that can advance both glossy and rough materials to produce images of high fidelity.

### SUMMARY OF THE INVENTION

The present invention has been made in consideration of the above described problems and needs. According to one aspect of the present invention, a second roller is used to reduce frictions created between a scanning document and an image sensing module. Consequently, the net driving force acting upon the scanning object is greatly increased and thus reducing the aforementioned problems of skewing or misfeeding in advancing the scanning document in sheet-fed scanner.

A traditional scanner uses one-sided drive with a rubber surface that moves a scanning sheet through the scanner. When, for example, a glossy photo sheet is being moved between the rubber surface drive on one side and the image sensing module (with a glass material in contact) on the other side, the motion of the sheet can do wrong (i.e. skewing or misfeeding). This is largely caused by strong friction between the glossy side and the glass material, resulting an uneven advancement of the sheet, hence smeared image thereof.

According to one embodiment of the present invention, a transparent circular tube as the second roller is used. The image sensing module is enclosed in the transparent circular tube. With a parallel mounting of the transparent circular tube and a motion roller, the transparent circular tube is caused to rotate in synchrony with the motion roller by friction created between a scanning sheet and the transparent circular tube so as to reduce the friction to maintain a net driving force from the motion roller. As a result, a scanning sheet can move smoothly.

Accordingly, one of the objects in the present invention is to provide a mechanism that can advance a scanning sheet smoothly regardless of its surface nature.

Other objectives, together with the foregoing are attained in the exercise of the invention in the following description and resulting in the embodiment illustrated in the accompanying drawings.

### BRIEF DESCRIPTION OF DRAWINGS

The current invention will be better understood and the nature of the objectives set forth above will become apparent when consideration is given to the following detailed description of the preferred embodiments. For clarity of explanation, the detailed description further makes reference to the attached drawings herein:

FIG. 1 shows a schematic configuration in which the present invention may be practiced;

FIG. 2A to FIG. 2C show respectively three different views of the internal structures of a typical sheet-fed scanner;

FIG. 3 illustrates a cross sectional view of the main module of a typical sheet-fed scanner relevant to the present invention;

FIG. 4 illustrates the transport of a scanning object, for example, a paper sheet, through a scanner, wherein various collective forces acting upon the scanning object are illustrated with a set of arrows to indicate corresponding directions;

FIG. 5 illustrates a cross sectional view of a sheet-fed scanner employing one embodiment of the present invention;

FIG. 6 illustrates, according to one embodiment of the present invention, a perspective view of a transparent circular tube enclosing an image sensing module in parallel contact with a motion roller, between which a scanning sheet is being advanced;

FIG. 7 illustrates a side view of a scanner employing one embodiment of the present invention; and

FIG. 8 shows that one embodiment of the present invention is used in a low profile contact image sensor.

### DETAILED DESCRIPTION OF THE PREFERRED EMBODIMENT

In the following detailed description of the present invention, numerous specific details are set forth in order to provide a thorough understanding of the present invention. However, it will become obvious to those skilled in the art that the present invention may be practiced without these specific details. In other instances, well known methods, procedures, components, and circuitry have not been described in detail to avoid unnecessary obscuring aspects of the present invention. The detailed description is presented largely in terms of procedures, logic blocks, processing, and other symbolic representations that directly or indirectly resemble the operations of such class of devices. These process descriptions and representations are the means used by those experienced or skilled in the art to most effectively convey the substance of their work to others skilled in the art.

Reference herein to “one embodiment” or an “embodiment” means that a particular feature, structure, or characteristics described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations of the invention.

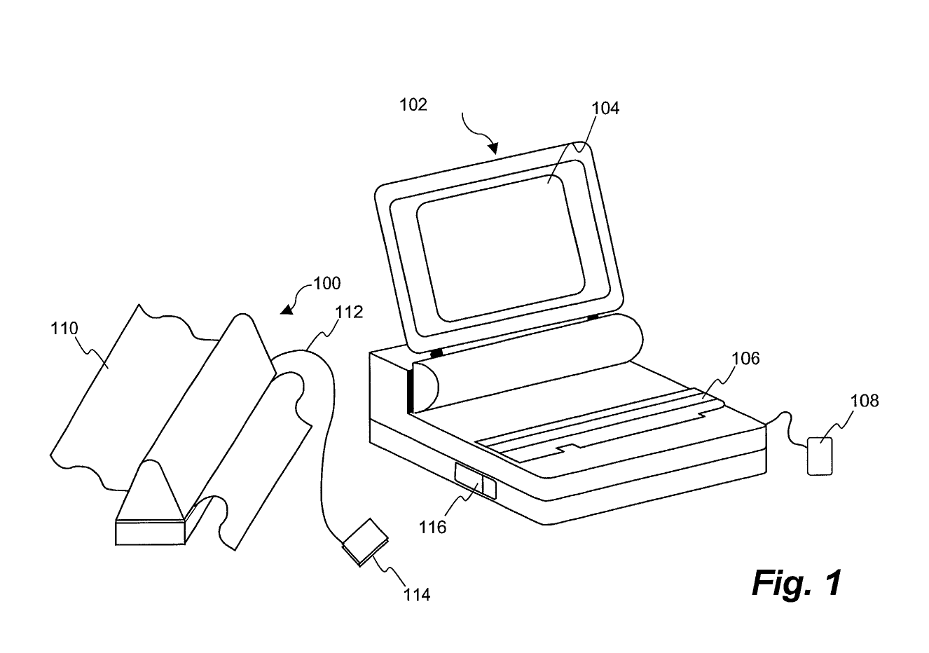

Referring now to the drawings, in which like numerals refer to like parts throughout the several views. FIG. 1 shows a schematic configuration in which the present invention may be practiced. Mobile scanner 100 is connected, through a communication cable 112 to an interface engine housed in a card 114 or to a USB connector of computing device 102. Computing device 102 which may be an IBM PC or PC-compatible notebook computer includes a receptacle or socket 116 coupled to the PC bus and controlled by the microprocessor in the computing device. The microprocessor is typically a powerful 32-bit microprocessor such as Pentium II from Intel Corporation.

When the interface card 114 or the cable 112 is received in the receptacle 116 (e.g. for a PCMCIA card, a USB connector or other dedicated connector), not only does the scanner receive a power supply from the computing system, typically 3.33 or 5V, the scanner also becomes integrated into the computing system, receiving system control signals from the powerful microprocessor. Furthermore, computing device 102 operates an application program preferably under an operating system with graphical user interface, for example, Microsoft Windows 2000 or ME. The application program, which is further described in detail in U.S. application Ser. No. 09/154,395, is a process that controls the operations of mobile scanner 100 via the interface engine housed in a card 114 or a USB connector.

Scanner 100 scans, line by line, a scanning object 415, such as a piece of paper or film with text and graphics on it. The scanning result, which is typically a digital representation of scanning object 415, is transferred to computer 102 through communication cable 112. The digital representation may be converted by the application program to a standard image format such as TIFF (Tag Image File Format) or BMP (Bitmap File Format), that may be manipulated for desired visual effects by another application program, such as PhotoShop 5.0 from Adobe Systems, Inc. The digital representation or manipulated digital image can be displayed on display monitor 104.

Computing device 102 is further provided with a floppy disk drive (not shown) with which removable floppy disk media may be read or written, fixed disk drive (not shown) for storing image files and application program files, a keyboard 106 for permitting input of text data, such as titles and names for scanned image files, and a pointing device 108 such as a mouse or the like which is also provided to permit execution of commands, for example, to display the scanned object and to manipulate images thereof on display monitor 104.

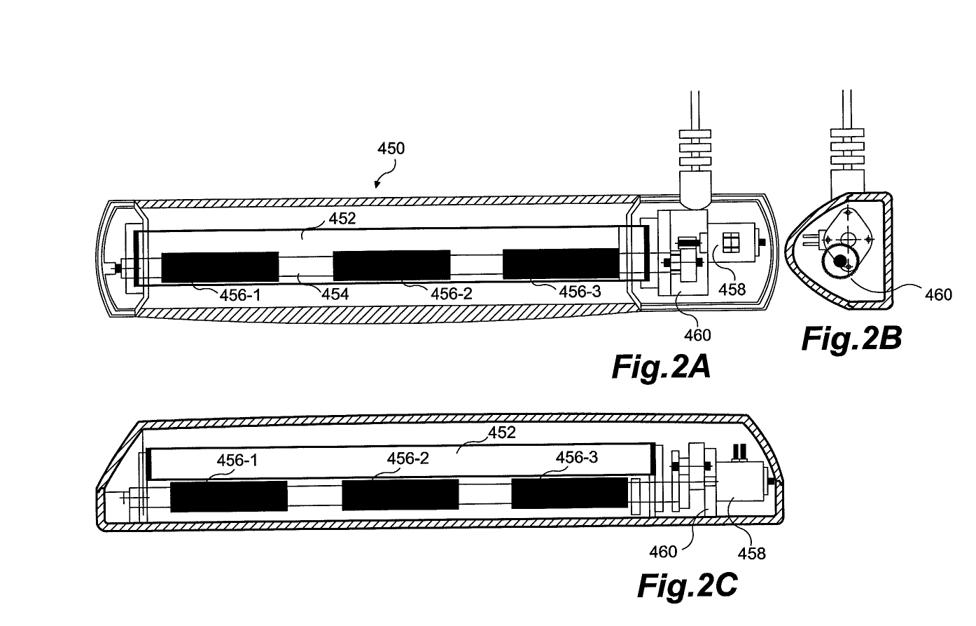

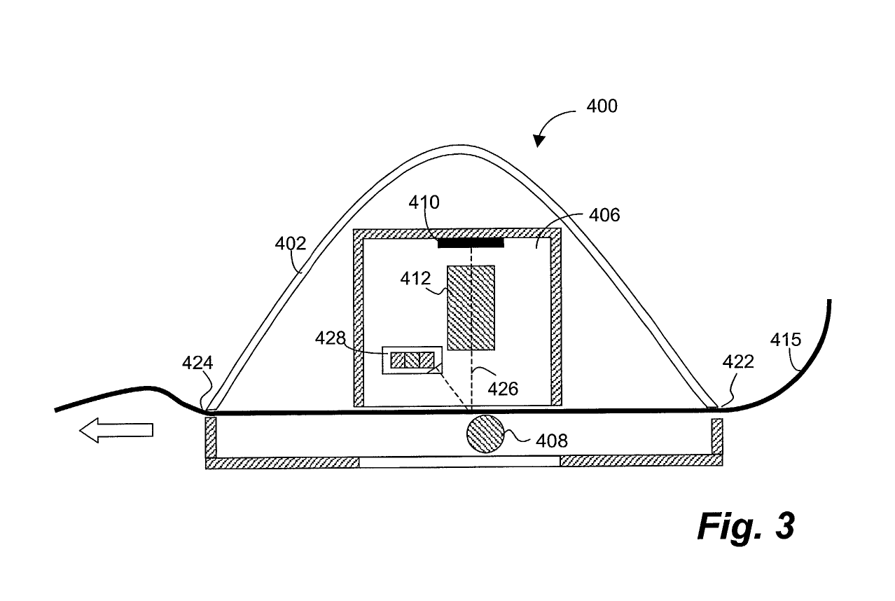

FIG. 2A to FIG. 2C show respectively three different views of the internal structure of main module 452 of a typical sheet-fed mobile scanner 450 that may correspond to scanner 100. Image sensing module 452 is an integrated and elongated part that includes an array of photodetectors, an illumination source and an optical system, which are shown in detail in FIG. 3. Shaft 454, also referring to motion roller or rod herein, including one or more rubber-surfaced tubes 456 is rotated by a motor 458 through a gearbox 460. When a scanning sheet, not shown in the figure, is inserted into the scanner, motor 458 causes shaft 454 to rotate at a speed adjusted by gear box 460 and the scanning object is then carried along by rubber surfaced tube 456 to move against image sensing module 452 so that the scanning object can be scanned completely.

FIG. 3 illustrates a cross sectional view 402 of a typical sheet-fed mobile scanner 400 relevant to the present invention. Module view 402 includes receiving opening 422 and exiting opening 424 for the entry and exiting of scanning object 415. Inside module view 402, scanning object 415 is driven past, scan line by scan line by rubber-surfaced tube 456, while maintained in close contact with image sensing module 406. The direction of motion or rotation of scanning object 415 and rubber-surfaced tube 456 are indicated by corresponding arrows. Image sensing module 406 performs the function of converting, scan line by scan line, the document image of scanning object 415 into appropriate electronic signals. Image sensing module 406 includes illumination source 428, lens 412 and image sensor 410. Thus, light from illumination source 428 are collected and reflected via optical path 426 and focused by lens 412 onto image sensor 410 that converts scan lines of image lights into appropriate electronic signals. Preferably, image sensor 410 is an array of Complementary Metal-Oxide Semiconductor (CMOS) photodetectors, each producing a charge signal when being exposed to incident light. Generally, the number of photodetectors in the array depends on the maximum size of scanning object 415 the scanner is designed to accommodate the resultant image resolution. For example, a letter-sized paper has a size of 8.5×11 inches. For a resolution of 300 dpi (dots per inch), the number of photodetectors is about 9×300=2,700 wherein a margin of 0.5 inch is added along the direction of 8.5 inch width. Further description of the image sensing module is provided in U.S. application Ser. No. 09/154,395.

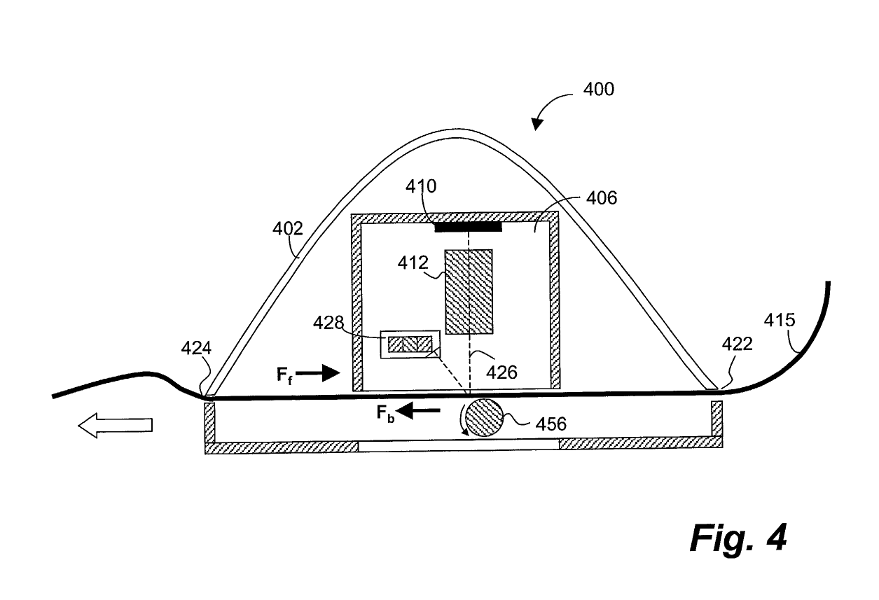

With reference to FIGS. 2A-2C, FIG. 4 illustrates the transport of a scanning object 416, for example, a paper sheet, through main module 402 wherein various collective forces acting upon the scanning object 416 are illustrated with a set of arrows to indicate corresponding directions. For example, there is a back-side force F_{b} pointing to the left. Although various factors may contribute to the back-side force F_{b}, it is largely produced by rubber-surfaced motion roller 456 rotating in a counter clockwise direction against the back of the scanning object. At the same time, there is a front-side force F_{f} pointing to the right. Although various frictions may contribute to the front-side force F_{f}, it is largely caused by friction between the top surface of scanning object 416 and the bottom (e.g. glass) surface of image sensing module 406. Therefore, the resultant net force Fₙₑₜ acting upon nominal-friction scanning object 416 for its transport through sheet-fed mobile scanner 400 is given by:

Fₙₑₜ=F_{b}−F_{f}

wherein Fₙₑₜ, F_{b} and F_{f} shall be in vector expression. For simplicity, Fₙₑₜ, F_{b} or F_{f} may also be used to indicate a magnitude thereof. Those skilled in the art can appreciate the exact meaning of a symbol or symbols given the context.

When Fₙₑₜ is positive, namely F_{b}>F_{f}, scanning object 415 will be moving forward along the direction of F_{b}. When Fₙₑₜ is close to zero, namely F_{b} and F_{f} are substantially close to each other, scanning object 415 will be moving slowly or hesitantly. It is understood that Fₙₑₜ exists everywhere along a scanning line when scanning object 415 is being moved along in contact with the bottom (e.g. glass) surface of image sensing module 406, though FIG. 4 shows F_{b} and F_{f} on one spot (on the cross section). If all Fₙₑₜ of the spots on a scanning line are substantially close to each other, then all of the spots will be advanced at the same time, hence scanning object 415 moves forward (leftward in the figure). However, if Fₙₑₜ of some spots are different from that of other spots, not all of the spots on the scanning line will be advanced at the same time, hence leading to misfeeding or skewing of the scanning object.

When scanning material 415 is a piece of regular office paper, the front-side force F_{f} is nominal and caused by a combination of upward pressure and motion of the rubber-surfaced roller. Since the surface of the regular office paper is rough relative to the bottom surface of image sensing module 406 (e.g. a glass surface), F_{f} is small everywhere, resulting in a relatively larger Fₙₑₜ. Therefore scanning materials like the office paper can be smoothly passed through the scanner.

When scanning material 415 is something like photo paper, one side is rough and the other side is polished or glossy. The front-side force F_{f} caused by a combination of upward pressure and motion of the rubber-surfaced tube tends to be substantial. One of the reasons that causes a larger F_{f} is the intimate contact between the polished side and the bottom surface of image sensing module 406. When all F_{f} along a scanning line are substantial or substantially different, the motion becomes hesitant, scanning material 415 could be misfed or skewed, resulting in a smeared image thereof.

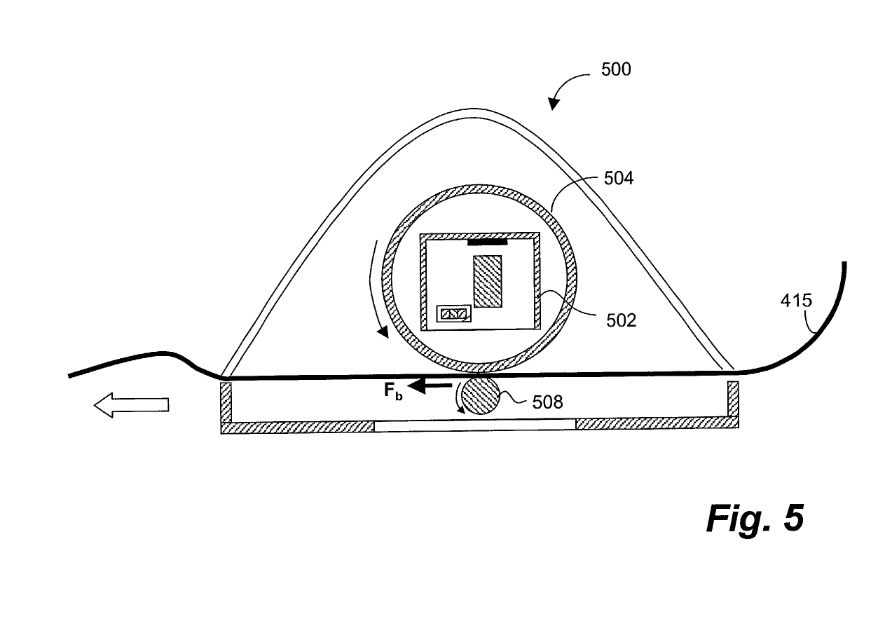

In light of the aforementioned problem, a sheet-fed scanner 502 employing one embodiment of the present invention is disclosed FIG. 5. The sheet-fed scanner 500 employs a second roller 504 to reduce the friction created between scanning sheet 415 and an image sensing module 502, now second roller 504.

According to one embodiment, image sensing module 502 is mounted within transparent circular tube 504. Specifically, image sensing module 502 is fixed in a house while the transparent circular tube is rotatably mounted in the house. The house may be made of a plastic material to all necessary parts of a scanner. In operation, when transparent circular tube 504 is caused to rotate, image sensing module 502 stays still.

Similar to the sheet-fed traditional scanner, a motor starts to drive a motion roller 508 when a scanning document is received between motion roller 508 and second roller 504. Motion roller 508 moves scanning sheet 415 through the image sensing module 502 for the scanning sheet to be scanned. However, mechanically different from the traditional scanner, the transparent circular tube is positioned in parallel and in close contact with the motion roller (e.g. a rubber-surfaced rod). The motion roller is motorized by a motor and causes the scanning sheet to move along. When the scanning document is received between the image sensing module and the motion roller, a pressure as well as the back force back-side force F_{b} induce frictions between the scanning document and the image sensing module. As now the transparent circular tube is rotatable, the frictions causes the transparent circular tube to rotate and is essentially reduced by the rotation of the transparent circular tube. As a result, the scanning document can be moved along without hesitation while the image sensing module in the transparent circular tube scans the scanning document as it goes by.

Specifically, when the scanning material is photo paper like material, the large front-side force F_{f} is reduced by the rotation of the transparent tubular enclosure, hence to retain F_{b} or keep Fₙₑₜ(=F_{b}−F_{f}) as effective as possible, so that the scanning sheet could be moved forward without any hesitations. Thus the fundamental problem of the large front friction force or the “sticky” situation is alleviated.

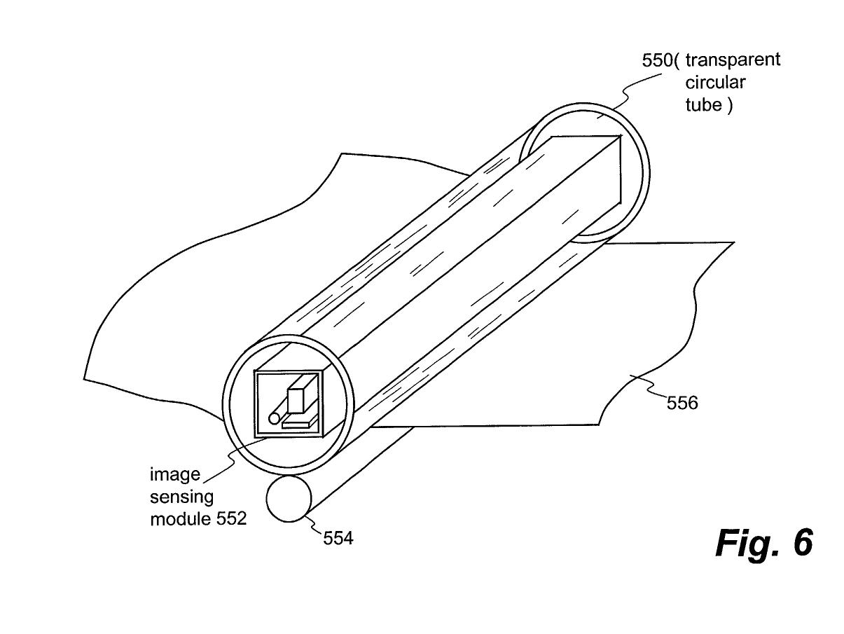

FIG. 6 illustrates, according to one embodiment of the present invention, a perspective view of a transparent circular tube enclosing an image sensing module in parallel contact with a motion roller, between which a scanning sheet is being advanced.

According to another embodiment, transparent circular tube 504 can be also driven by the motor that drives the motion roller 508 but in an opposite direction. This may further ensure that the scanning sheet will be advanced as desired.

Accordingly to still another embodiment, transparent circular tube 504 can be driven by the motion roller through one or more gears and rotates in synchrony with the motion roller but in an opposite direction.

Accordingly to still another embodiment, the operation of the image sensing module is synchronized with the rotation of the transparent circular tube. That means that the image sensing module is configured to only scan when an effective rotation of the transparent circular tube takes place, which may greatly reduce any possibility of misreading the scanning sheet (i.e. generating multiple signals of the same scanning line).

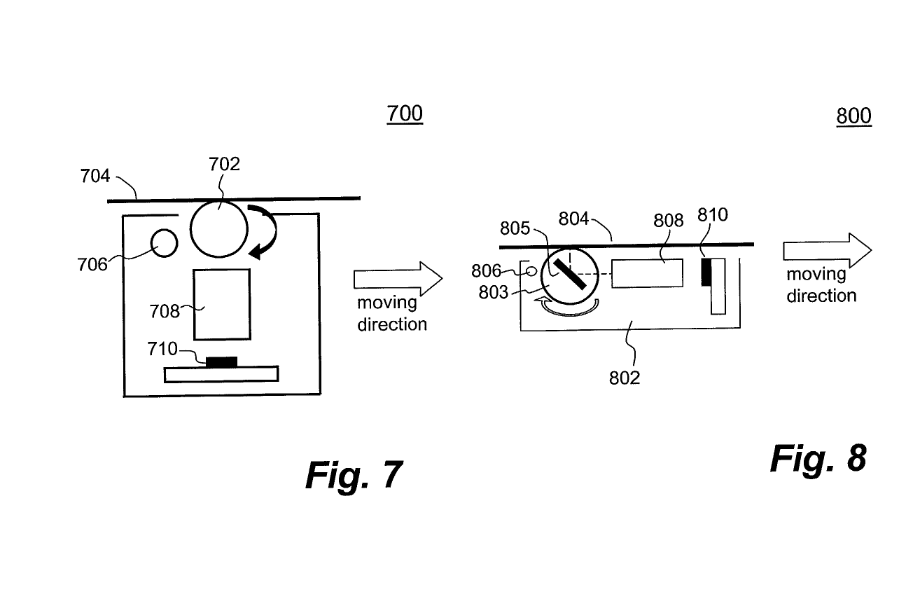

FIG. 7 illustrates a side view 700 of a scanner (e.g. a flatbed scanner) employing one embodiment of the present invention. In this design, the image sensing module 552 is not enclosed in the glass transparent circular tube 550 as shown in FIG. 6. Instead, a glass rod 702 (either solid or hollow) is employed to assist scanning document 704 to move forward. When a frictional force is created, glass rod 702 is caused to rotate so as to reduce the frictional force to keep the scanning document to move forward. As shown in the figure that is different from FIG. 6, illumination source 706, optical lens system 708 and sensor 710 are so positioned that the reflected light from scanning document 704 is passed through glass rod 702 and focused by optical lens system 708 onto image sensor 710. One of the advantages and benefits of the design is to “convert” the friction between a shinny material and a glass material into a motion force.

In some applications, the design in FIG. 7 may be large in size and difficult to fit in some small devices (e.g. palm computing devices) because of the resultant physical size of the image sensing module. Typically, once the focal length is determined for a scanner, the optical lens system (e.g. 708 of FIG. 7) is fixed. Co-pending U.S. application Ser. No. 09/829,259 discloses a new design of changing the optical path by using a mirror, the new design is referred to as “low profile” image sensing module. FIG. 8 shows that one embodiment of the present invention is being employed in a low profile image sensing module 803 in which a hollow glass roller 803 is used. As shown in the figure, glass roller 803 encloses a mirror 805 that reflects reflected light from the scanning document 804 to the optical lens system 808 that collects and focus the reflected light onto a sensor 810. According to one embodiment, the mirror 805 is mounted and fixed at a predetermined angle in a house housing the scanner but enclosed in a rotatable glass roller 803. In other words, when glass roller 803 rotates, mirror 805 remains still. The reflected light goes through the transparent glass roller and then redirected to the optical lens system. The new design can substantially reduce the size (e.g. height) that is otherwise necessary to house the vertical placed lens system (shown in FIG. 7).

The advantages of the invention are numerous. One advantage of the invention is that now a sheet-fed scanner can accommodate various scanning materials. Another advantage is that a scanning material can be advanced in a controllable manner while being scanned by the image sensing module inside the transparent circular tube. Many other features and advantages of the present invention are apparent from the written description, and thus, it is intended by the appended claims to cover all such features and advantages of the invention. Further, since numerous modifications and changes will readily occur to those skilled in the art, it is not desired to limit the invention to the exact construction and operation as illustrated and described. Hence, all suitable modifications and equivalents may be considered to fall within the scope of the invention.

I claim:

1. A scanner comprising:
a transparent circular tube;
an image sensing module mounted within the transparent circular tube; and
a motion roller mounted in parallel with and substantially close to the transparent circular tube, the motion roller driven by a motor and rotating in a first direction and the transparent circular tube rotating in a second direction to move a scanning document along when the scanning document is fed between the transparent circular tube and the rubber-surfaced rod, wherein the image sensing module scans the scanning document as the scanning document moves along image sensing module.

2. The scanner of claim 1, wherein the transparent circular tube is made of a material that transmits light efficiently.

3. The scanner of claim 2, wherein the material is glass.

4. The scanner of claim 2, wherein the material is transparent plastic.

5. The scanner of claim 1, wherein the transparent circular tube is rotatably mounted in the scanner so that any friction from the scanning document will cause the transparent circular tube to rotate freely to avoid the scanning document being hesitantly moved along.

6. The scanner of claim 5, wherein the first direction and the second direction is opposite.

7. The scanner of claim 5, wherein the friction is caused when the scanning document is in close contact with the transparent circular tube and at the same time being moved along.

8. The scanner of claim 2, wherein the image sensing module scans the scanning document from the inside of the transparent circular tube.

9. The scanner of claim 2, wherein the image sensing module scans the scanning document when the transparent circular tube is caused to rotate.

10. The scanner of claim 9, wherein the image sensing module scans the scanning document in synchrony with the rotation of the transparent circular tube.

11. The scanner of claim 1, wherein the first direction and the second direction is opposite and wherein the transparent circular tube is also driven by the motor to rotate in the second direction.

12. A scanner comprising:
a house having an entrance to receive a scanning document and an exit to pass the scanning document out;
a motor mounted in the house;
a sensor for detecting a presence of the scanning document to activate the motor;
a transparent circular tube rotatably mounted in the house;
an image sensing module mounted within the transparent circular tube;
a motion roller mounted in parallel with and substantially close to the transparent circular tube, the motion roller driven by the motor and rotating in a direction and the transparent circular tube rotating in an opposite direction to move the scanning document along when the scanning document is received between the transparent circular tube and the motion roller, wherein the image sensing module scans the scanning document as the scanning document moves along image sensing module to generate an electronic image thereof.

13. The scanner of claim 12, wherein the transparent circular tube and the motion roller rotate in synchrony with each other.

14. The scanner of claim 12, wherein the transparent circular tube is caused to rotate by a friction force caused between the scanning document and the transparent circular tube.

15. The scanner of claim 12, wherein the motion roller is rubber-surfaced.
